(19) United States
(12) Patent Application Publication
(10) Pub. No.: US 2002/0062467 A1
(43) Pub. Date: May 23, 2002

(54) System and method for reliable billing of content delivered over networks

(76) Inventor: Jason F. Hunzinger, Carlsbad, CA (US)

Correspondence Address: SCOTT C. HARRIS, Fish & Richardson P.C., Suite 500, 4350 La Jolla Village Drive, San Diego, CA, 92122, US

(21) Appl. No.: 09/990,055

(22) Filed: Nov. 21, 2001

Related U.S. Application Data
(60) Provisional application No. 60/252,994, filed on Nov. 22, 2000.

(51) Int. Cl. H04L 1/18

(52) U.S. Cl. 714/749

(57) ABSTRACT

In an embodiment, a mobile device in a wireless network may request content from a content provider connected to the Internet. A gateway device may connect the mobile devices in the wireless network to the Internet. The content provider may send content to the mobile device via the gateway device in response to a request message sent by the mobile device. Upon successful receipt of the content, the mobile device may issue a delivery confirmation acknowledgment (C-ACK) to the gateway device. In response to receiving the C-ACK, the gateway device or content provider may issue a display acknowledgment (D-ACK) to the mobile device. The mobile device may not display or otherwise utilize the received content until it receives the D-ACK.

### CROSS-REFERENCE TO RELATED APPLICATIONS

This application is claims priority to U.S. Provisional Application Serial No. 60/252,994, entitled RELIABLE BILLING OF CONTENT DELIVERED ON UNRELIABLE NETWORKS and filed on Nov. 22, 2000.

### BACKGROUND

The sale of content over the Internet is becoming an important source of revenue for the Internet industry. A content provider may deliver text, video, music or other forms of content to a requesting consumer and bill the consumer for the delivered content.

For a content usage-based billing system to be efficient, the content providers must reliably receive payment for successfully delivered content, and the consumers must reliably receive the content they are billed for in a complete and uncorrupted form.

Wireless networks are used to connect mobile devices, such as laptops and handheld devices such as mobile phones, pagers, two-way radios, and PDAs (Personal Digital Assistants), to the Internet. Such mobile devices may be used to purchase content from content providers over the Internet. However, wireless networks may not always be reliable due to the dynamics of mobility and limited bandwidth available on wireless links. Also, wireless networks may have higher error rates and more frequent disconnections than wired networks. These reliability issues may complicate the implementation of efficient content usage-based billing in wireless networks.

### SUMMARY

In an embodiment, a mobile device in a wireless network may request content from a content provider connected to the Internet. The content may include, for example, text, images, video and/or audio information, and script(s) and program(s). A gateway device may connect the mobile devices in the wireless network to the Internet. The wireless communication link between the gateway device and a mobile device may be less reliable that the link between the gateway device and the content provider via the Internet.

The content provider may send content to the mobile device via the gateway device in response to a request message sent by the mobile device. Upon successful receipt of the content, the mobile device may issue a delivery confirmation acknowledgment (C-ACK) to the gateway device. In response to receiving the C-ACK, the gateway device or content provider may issue a display acknowledgment (D-ACK) to the mobile device. A billing system may then bill the requesting user for the delivered content.

The mobile device may not display or otherwise utilize the received content until it receives the D-ACK. For example, the content may be encrypted and the D-ACK may include the decryption key. Alternatively, the content may be sent with a script or program that disables the mobile device from displaying or otherwise utilizing the received content until a D-ACK is received.

### BRIEF DESCRIPTION OF THE DRAWINGS

FIG. 1 is a networked computer system which supports reliable content usage-based billing.

FIGS. 2A and 2B are flowcharts describing a content usage-based billing operation.

FIG. 3 is a block diagram illustrating a protocol for reliable content usage-based billing.

### DETAILED DESCRIPTION

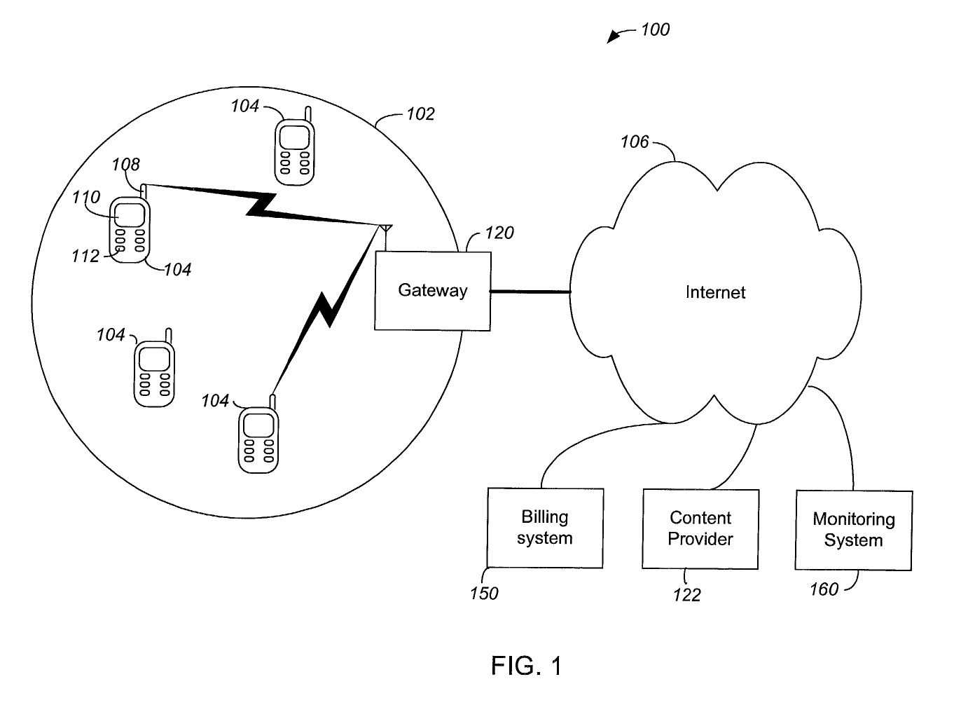

FIG. 1 illustrates a networked computer system 100 which enables a content usage-based billing technique according to an embodiment. The networked computer system may include a wireless communication network 102 that supports and manages wireless connections between mobile devices 104 and the Internet 106 or a similar networked computer system. The wireless communication network may utilize the Wireless Application Protocol (WAP), a specification that allows users to access information from a network via handheld wireless devices in a secure manner.

The mobile devices 104 may include antennas 108 or optical transceivers for receiving and transmitting wireless signals, such as radio frequency (RF) or infrared (IR) signals. The mobile devices 104 may include display screens 110, speakers and/or jacks audio output, and keypads 112 for inputting user commands. The mobile devices 104 may include, for example, mobile phones, pagers, two-way radios, and PDAs (Personal Digital Assistants).

A gateway device 120 in the wireless network 102 may be used to connect the mobile devices 104 to the Internet 106. The gateway device 120 communicates with the mobile devices via wireless connections and with the Internet via a more reliable connection, e.g., an unshielded twisted pair (UTP), fiber optic or co-axial cable or a combination of such cables. The gateway device 120 may translate data between WAP and TCP/IP (Transmission Control Protocol/Internet Protocol) formats utilized in the wireless network 102 and the Internet 106, respectively.

The mobile devices 104 may be used to purchase content from content providers over the Internet. A content provider 122 may deliver text, video, music, scripts, programs or other forms of content to the requesting consumer via a mobile device 104 and bill the consumer for the delivered content. The content may also be delivered as part of a service, such as financial, entertainment, and location services.

In an effective content usage-based billing system, both content delivery to the consumer and billing by the content provider are both performed reliably and consistently. However, wireless networks may not always be reliable due to the dynamics of mobility and limited bandwidth available on wireless links. Also, wireless networks may have higher error rates and more frequent disconnections than wired networks. In a content usage-based billing system, such unreliability may cause a consumer to be billed for content that was not delivered or incompletely delivered. The content provider may not be certain that the consumer has received the content, and hence may not be able to properly bill the consumer. These occurrences may result in consumer dissatisfaction, complaints, repeated delivery attempts (and the resultant increase in network traffic), and loss in revenue.

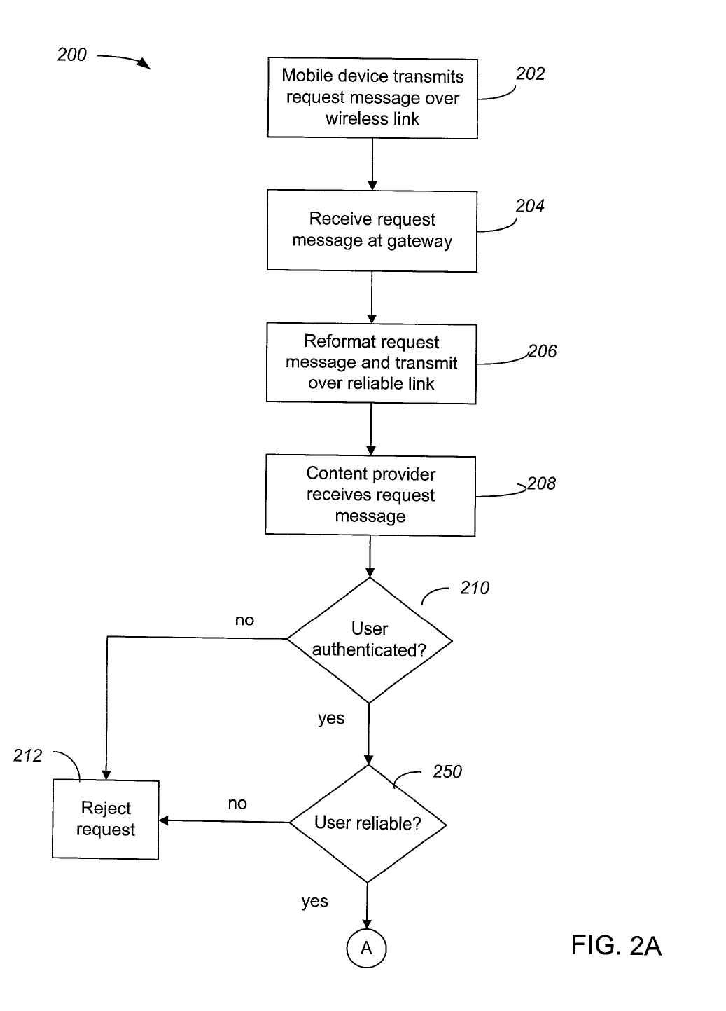

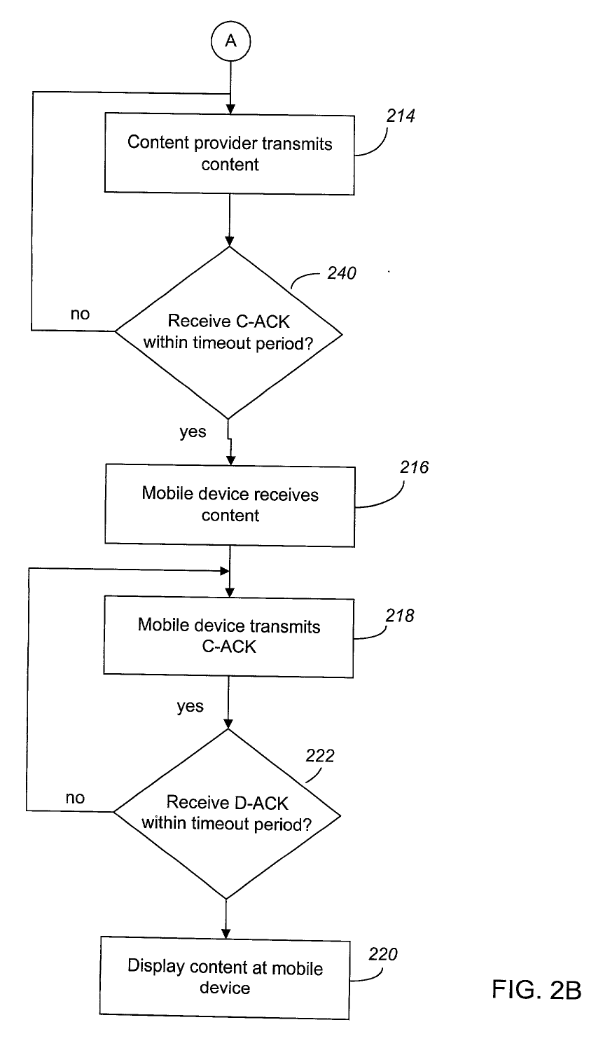

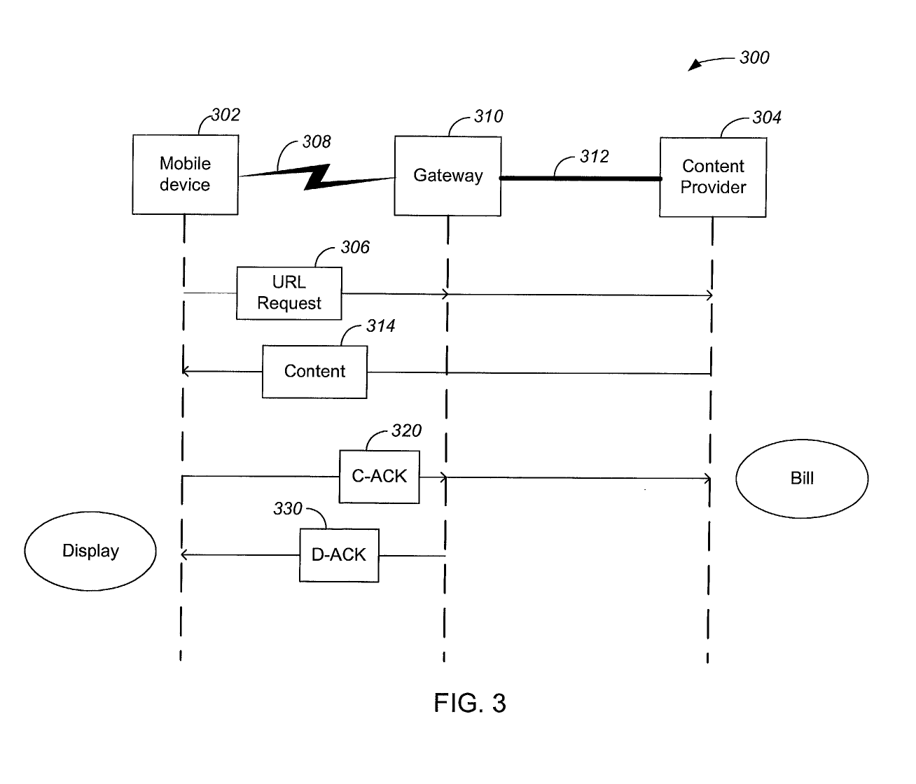

FIG. 2 is a flowchart describing an operation 200 for fair and reliable billing of content delivery. A mobile device 302 requests content from a content provider 304 by transmitting a request message 306 identifying the desired content over a wireless connection 308 (block 202), as shown in FIG. 3. A gateway device 310 receives the request message over the wireless connection 308 (block 204), performs any necessary reformatting of the data, and forwards the request message 306 to the content provider 304 over an Internet connection 312 using a reliable transmission protocol, such as TCP/IP (block 206).

Upon receipt of the request message 306 (block 208), the content provider 304 may authenticate the user (block 210) and then either reject the request (block 212) or send the requested content 314 (block 214). The mobile device sends back a content-delivery acknowledgment (C-ACK) 320 (block 218) once the complete information entity, e.g., a page (TCP/IP) or deck or card (WAP), has been received and stored successfully and uncorrupted (block 216). The mobile device and content provider may use a Cyclic Redundancy Check (CRC), a TCP packet length indicator, an FTP file size indicator or any other well known method of allowing a recipient to determine that it has received a complete information entity.

Upon receipt of the C-ACK from the mobile device 302, a network component may issue a display-acknowledgment (D-ACK) 330. The mobile device may not display or otherwise manifest the delivered content (e.g., audio output) until the D-ACK is received (block 220). If the gateway device 120 or content provider 122 does not receive a C-ACK from the mobile device after a timeout period after transmitting the content, that entity may retransmit the content (block 240).

The D-ACK may be a OSI (Open System Interconnection) Layer 2 (Data Link) acknowledgment of the C-ACK bearing message. To account for losses over the wireless connection 308, the mobile device may send one or more C-ACKs if an expected D-ACK is not received within a timeout period (block 222).

Although wireless connection 308 may not be reliable, the Internet connection 312 is considered reliable and any data received by the gateway device from the wireless connection 308, e.g., a request message or C-ACK, is assumed to be successfully transmitted and received by the content provider 304. Accordingly, the network component may be the content provider 304, the gateway 310, or another network component on the other side of the unreliable link, i.e., the wireless connection 308. If acknowledged in this way, it is highly probable that the C-ACK reaches the billing entity because the remainder of the link is highly. Upon receiving a C-ACK, a billing system 150 may check for funds and handles the payment for the transaction.

As described above, the mobile device 302 does not display the delivered content until a D-ACK is received from the network component. The content may be encrypted and require a key contained in the D-ACK, or the information may be weakly scrambled or encrypted. Alternatively, the mobile device 302 may be configured to suppress display or other manifestation (e.g., audio output or printing) of the content until the D-ACK is received.

The content may be delivered to the mobile device in an information package, which may also include billing script(s) or program(s), conditional display script(s) or program(s), and tags for other purposes such as identification, billing, and tracking. The tags and scripts or programs may be included by the content provider or appended, attached, or packaged by other entities such as the gateway 12 or billing system 150. The billing scripts may cause the mobile device to implement the C-ACK acknowledgment protocol and identification of the mobile device or user. The conditional display scripts may cause the mobile device 104 to store and/or hide all or part of the content until the D-ACK is received.

Users could potentially discover a way to view internally stored content before a D-ACK is received or to block the billing or conditional display scripts and thereby obtain free content. A monitoring system 160 may be used to keep track of the statistics of content delivery and C-ACKS from individual users. To protect user privacy, devices or users may be identified with arbitrary identifiers which are associated with the appropriate device or user at the monitoring system, content provider, billing system, gateway, or other entity. Before providing content, the content provider 122 or billing system 150 (or other entity) may check with the monitoring system 160 to see if a particular user (identified by the anonymous or non-anonymous ID) has a bad history of not acknowledging delivery (block 250). If this is the case, the user's request may be denied (block 212) because the user is not trusted to pay, or the link is unreliable and there is a low probability of delivery and confirmation. FIG. 1 depicts the content provider 122, billing system 150 and monitoring system 160 as separate entities connected to the internet 106, however it is well understood in the art that some or all of their functions could be collocated on the same device.

The techniques described here may be implemented in hardware or software, or a combination of the two. The techniques may be implemented in computer programs executed on one or more programmable computers that may each includes a processor, a storage medium readable by the processor (including volatile and non-volatile memory and/or storage elements), and suitable input and output devices. The programmable computers may be either general-purpose computers or special-purpose, embedded systems.

A number of embodiments of the present invention have been described. Nevertheless, it will be understood that various modifications may be made without departing from the spirit and scope of the invention. For example, blocks in the flowchart used to describe the content usage-based operation may be skipped or performed in a different order and produce desirable results. Accordingly, other embodiments are within the scope of the following claims.

1. A method comprising:
requesting content over a communication link;
receiving the requested content;
sending a first acknowledgment acknowledging receipt of the content;
receiving a second acknowledgement; and
enabling utilization of the received content in response to receiving the second acknowledgement.

2. The method of claim 1, further comprising disabling utilization of the requested content until the second acknowledgment is received.

3. The method of claim 1, wherein the communication link is a wireless link.

4. The method of claim 1, wherein the content comprises at least one of textual, graphical and video information, and said utilization comprises displaying said content.

5. The method of claim 1, wherein the content comprises audio information, and said utilization comprises outputting an audio signal representative of said audio information.

6. The method of claim 1, wherein the content comprises at least one of a script or a program, and said utilization comprises running said script or program.

7. The method of claim 1, wherein said receiving the content comprises storing the received content and suppressing utilization of said content until the second acknowledgement is received.

8. The method of claim 1, further comprising resending the first acknowledgement in response to not receiving the second acknowledgment within a timeout period.

9. The method of claim 1, wherein said receiving content comprises receiving instructions operative to disable utilization of the received content until the second acknowledgment is received.

10. The method of claim 1, wherein said content is encrypted, and wherein said receiving said second acknowledgment comprises receiving a decryption key.

11. A method comprising:
receiving a request for content from a requesting device;
sending the requested content to the requesting device; and
transmitting a utilization acknowledgment to the requesting device in response to receiving a delivery confirmation acknowledgment from the requesting device, said utilization acknowledgment being operative to enable the requesting device to utilize the content.

12. The method of claim 11, wherein said transmitting the utilization acknowledgement comprises transmitting a display acknowledgment operative to enable the requesting device to display the content.

13. The method of claim 11, further comprising authorizing billing for the requested content in response to receiving the delivery confirmation acknowledgment from the requesting device.

14. The method of claim 11, wherein said receiving the request comprises receiving the request over a first communication link.

15. The method of claim 14, further comprising forwarding the request over a second communication link, wherein said second communication link is more reliable than said first communication link.

16. The method of claim 15, wherein the first communication link comprises a wireless link.

17. The method of claim 15, wherein the second communication link comprises a wired link.

18. The method of claim 11, further comprising retransmitting the requested content in response-to not receiving a delivery confirmation acknowledgment from the requesting device within a timeout period.

19. The method of claim 11, further comprising determining a history of delivery confirmation acknowledgment by said requesting device and wherein said sending the requested content to said requesting device is only performed if said history does not indicate a discrepancy.

20. A system comprising:
a content provider connected to a first network and operative to transmit content requested by a user station connected to a second network;
a gateway device connected to the first network and the second network, said gateway device operative to forward the requested content to the user station and to transmit a utilization acknowledgment operative to enable the user station to utilize the requested content in response to receiving a delivery confirmation acknowledgment from the user station; and
a billing system operative to bill a user for the delivered content in response to the display acknowledgment being transmitted.

21. The system of claim 20, wherein the content provider is operative to generate the display acknowledgment in response to receiving the delivery confirmation acknowledgement via the gateway device.

22. The system of claim 20, wherein the gateway device is operative to generate the display acknowledgment in response to receiving the delivery confirmation acknowledgement from the user station.

23. The system of claim 20, wherein the first network is more reliable than the second network.

24. The system of claim 23, wherein the first network is a wired network.

25. The system of claim 23, wherein the second network is a wireless network.

26. The system of claim 25, wherein the user station comprises a mobile device.

27. The system of claim 20, wherein said content provider further determines a history of delivery confirmation acknowledgment by said user station and wherein said sending of said content requested by said user station is only performed if said history does not indicate a discrepancy.

28. An article comprising a machine-readable medium including machine-executable instructions, the instructions operative to cause a machine to:
request content over a communication link;
receive the requested content;
send a first acknowledgment acknowledging receipt of the content;
receive a second acknowledgement; and
enable utilization of the received content in response to receiving the second acknowledgement.

29. The article of claim 28, further comprising instructions operative to cause the machine to disable utilization of the received content until the second acknowledgment is received.

30. An article comprising a machine-readable medium including machine-executable instructions, the instructions operative to cause a machine to:
receive a request for content from a requesting device;
send the requested content to the requesting device; and
transmit a utilization acknowledgment to the requesting device in response to receiving a delivery confirmation acknowledgment from the requesting device, said utilization acknowledgment being operative to enable the requesting device to utilize the content.

31. The article of claim 30, further comprising instructions operative to cause the machine to authorize billing for the requested content in response to receiving the delivery confirmation acknowledgment from the requesting device.
